(19) United States
(12) Patent Application Publication
(10) Pub. No.: US 2018/0252207 A1
(43) Pub. Date: Sep. 6, 2018

(54) PERISTALTIC PUMP AND RELATED METHODS

(71) Applicant: PerkinElmer Health Sciences, Inc., Waltham, MA (US)

(72) Inventor: Brian Chan, Markham (CA)

(21) Appl. No.: 15/970,366

(22) Filed: May 3, 2018

Related U.S. Application Data
(63) Continuation of application No. 14/327,105, filed on Jul. 9, 2014, now abandoned.

(51) Int. Cl. F04B 43/12

(52) U.S. Cl. CPC F04B 43/1238; F04B 43/1292; F05C 2203/02; F04B 43/1261; F04B 43/1246

(57) ABSTRACT

A peristaltic pump for pumping a fluid includes a flexible tube and a roller. The flexible tube has inner and outer tubular opposed walls. The inner wall defines a through passage to receive the fluid. The roller has an outer contact surface. The peristaltic pump is configured to compress the flexible tube with the contact surface of the roller to thereby force the fluid through the through passage. At least the contact surface of the roller is formed of borosilicate glass.

### RELATED APPLICATIONS

The present application is a continuation of U.S. patent application Ser. No. 14/327,105, filed Jul. 9, 2014, the disclosure of which is incorporated herein in its entirety.

### FIELD

The present invention relates to pumps and, more particularly, to peristaltic pumps.

### BACKGROUND

Peristaltic pumps are commonly employed to displace or transfer a variety of fluids and may be particularly beneficial in pumping fluids that should be isolated from the environment. Peristaltic pumps typically include two or more rollers that are driven over a length of a flexible tube such that the tube is pinched (e.g., against a clamp) and the fluid contents of the tube are thereby driven through the tube. The rollers may be formed of stainless steel or poly(p-phenylene sulfide) (PPS), for example.

### SUMMARY

According to embodiments of the technology, a peristaltic pump for pumping a fluid includes a flexible tube and a roller. The flexible tube has inner and outer tubular opposed walls. The inner wall defines a through passage to receive the fluid. The roller has an outer contact surface. The peristaltic pump is configured to compress the flexible tube with the contact surface of the roller to thereby force the fluid through the through passage. At least the contact surface of the roller is formed of borosilicate glass.

In some embodiments, the contact surface engages the outer surface of the tube to compress the flexible tube.

According to some embodiments, the roller is formed substantially entirely of borosilicate glass.

According to some embodiments, the peristaltic pump includes a roller carrier and a roller axle pin coupling the roller to the roller carrier, and the roller axle pin is formed of borosilicate glass. In some embodiments, the roller axle pin is stationary with respect to the roller carrier and the roller is rotatable about the roller axle pin. In some embodiments, the peristaltic pump includes a roller bushing mounted between the roller axle pin and the roller to permit relative rotation therebetween. In some embodiments, the roller axle pin is integral with the roller.

According to some embodiments, the roller includes: a core of a material other than the borosilicate glass; and a cladding layer of borosilicate glass surrounding the core and forming the contact surface.

According to some embodiments, the peristaltic pump includes a plurality of rollers each having an outer contact surface formed of borosilicate glass, and the peristaltic pump is configured to compress the flexible tube with the contact surfaces of each of the rollers to thereby force the fluid through the through passage. In some embodiments, the peristaltic pump includes a roller carrier, wherein: the plurality of rollers are each rotatably mounted on the roller carrier; and the roller carrier is rotatable about a central axis such that the plurality of rollers orbit the central axis and sequentially compress the tube when the roller carrier is rotated about the central axis.

According to the embodiments of the technology, a method for pumping a fluid includes providing a peristaltic pump including: a flexible tube having inner and outer tubular opposed walls, the inner wall defining a through passage to receive the fluid; and a roller having an outer contact surface. The peristaltic pump is configured to compress the flexible tube with the contact surface of the roller to thereby force the fluid through the through passage. At least the contact surface of the at least one roller is formed of borosilicate glass. The method further includes pumping the fluid through the flexible tube using the peristaltic pumping including compressing the flexible tube with the contact surface of the roller to thereby force the fluid through the through passage.

In some embodiments, the fluid is corrosive or caustic to stainless steel.

In some embodiments, the fluid is an acid.

In some embodiments, pumping the fluid through the flexible tube using the peristaltic pump includes engaging the contact surface with the outer surface of the tube to compress the flexible tube.

In some embodiments, the roller is formed substantially entirely of borosilicate glass.

According to some embodiments, the peristaltic pump includes a roller carrier and a roller axle pin coupling the roller to the roller carrier, and the roller axle pin is formed of borosilicate glass. In some embodiments, the roller axle pin is stationary with respect to the roller carrier and the roller is rotatable about the roller axle pin. In some embodiments, the peristaltic pump includes: a mounting bore in the roller carrier; and a resilient securing member holding the roller axle pin in the mounting bore. In some embodiments, the roller axle pin is integral with the roller.

According to some embodiments, the roller includes: a core of a material other than borosilicate glass; and a cladding layer of borosilicate glass surrounding the core and forming the contact surface.

According to some embodiments, the peristaltic pump includes a plurality of rollers each having an outer contact surface formed of borosilicate glass, and pumping the fluid through the flexible tube using the peristaltic pump includes compressing the flexible tube with the contact surfaces of each of the rollers to thereby force the fluid through the through passage. In some embodiments, the peristaltic pump includes a roller carrier, the plurality of rollers are each rotatably mounted on the roller carrier, and pumping the fluid through the flexible tube using the peristaltic pump includes rotating the roller carrier about a central axis such that the plurality of rollers orbit the central axis and sequentially compress the tube when the roller carrier is rotated about the central axis.

Further features, advantages and details of the present technology will be appreciated by those of ordinary skill in the art from a reading of the figures and the detailed description of the preferred embodiments that follow, such description being merely illustrative of the present technology.

### BRIEF DESCRIPTION OF THE DRAWINGS

FIG. 1 is a top perspective view of a fluid management system according to embodiments of the technology.

FIG. 2 is a cross-sectional view of a pump assembly according to the embodiments of the technology forming a part of the fluid management system of FIG. 1 taken along the line 2-2 of FIG. 1.

FIG. 3 is a cross-sectional view of the pump assembly of FIG. 2 taken along the line 3-3 of FIG. 2.

FIG. 4 is a bottom perspective view of a rotor assembly forming a part of the pump assembly of FIG. 2.

FIG. 5 is an exploded, top perspective view of the rotor assembly of FIG. 4.

FIG. 6 is an enlarged, fragmentary, cross-sectional view of the pump assembly of FIG. 2 taken along the line 2-2 of FIG. 1.

FIG. 7 is an enlarged, fragmentary, cross-sectional view of the pump assembly of FIG. 2 taken along the line 3-3 of FIG. 2.

FIG. 8 is an enlarged, fragmentary, cross-sectional view of a pump assembly according to further embodiments of the technology.

FIG. 9 is a cross-sectional, perspective view of a roller assembly according to further embodiments of the technology.

### DETAILED DESCRIPTION

The present technology now will be described more fully hereinafter with reference to the accompanying drawings, in which illustrative embodiments of the technology are shown. In the drawings, the relative sizes of regions or features may be exaggerated for clarity. This technology may, however, be embodied in many different forms and should not be construed as limited to the embodiments set forth herein; rather, these embodiments are provided so that this disclosure will be thorough and complete, and will fully convey the scope of the technology to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present technology.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

Unless otherwise defined, all terms (including technical and scientific terms) used herein have the same meaning as commonly understood by one of ordinary skill in the art to which this technology belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The term “monolithic” means an object that is a single, unitary piece formed or composed of a material without joints or seams.

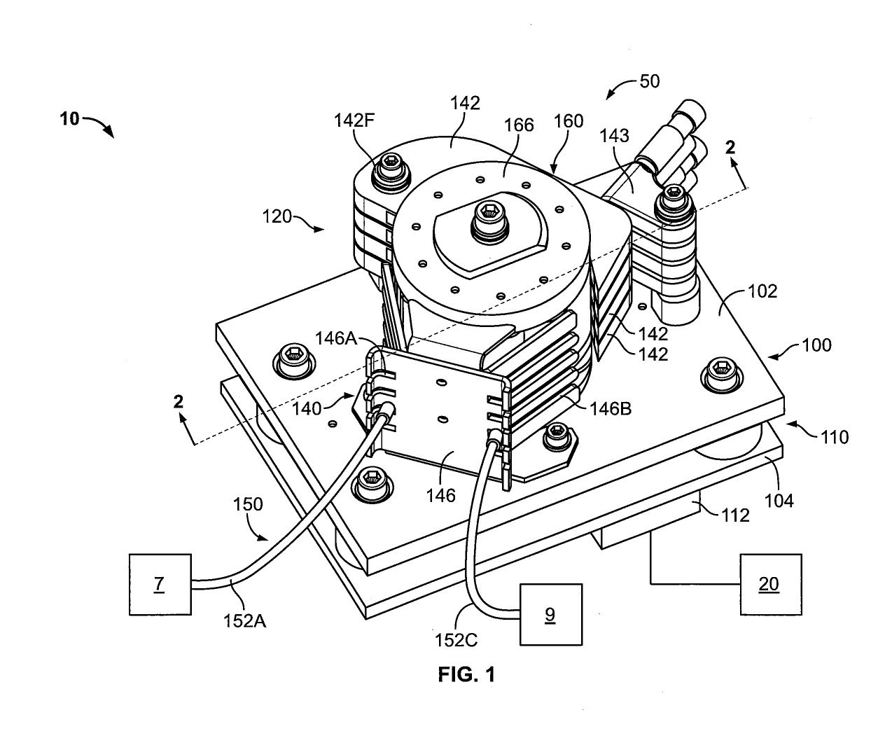

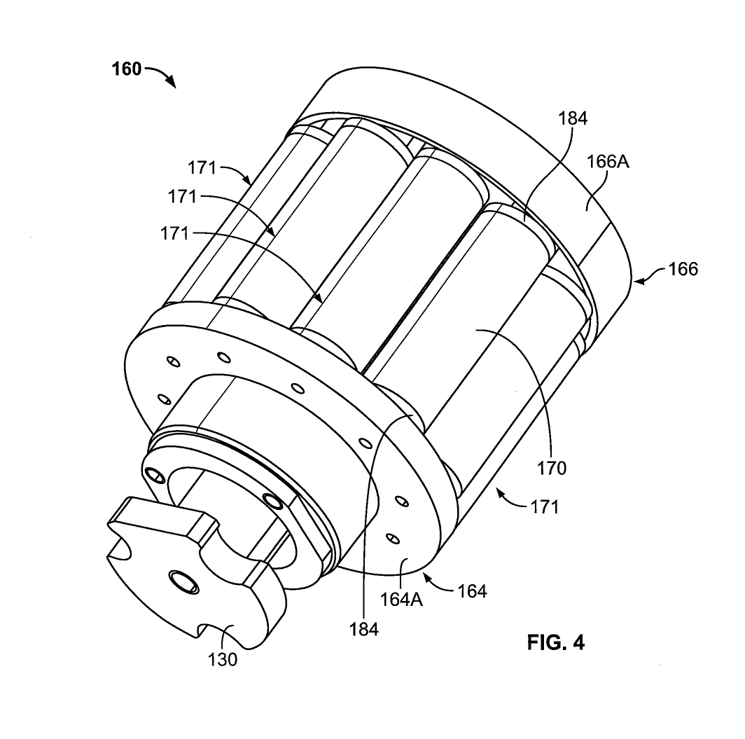

With reference to FIGS. 1-7, a fluid management system 10 according to embodiments of the technology is shown therein. The fluid management system 10 (FIG. 1) includes a pump assembly 50 according to embodiments of the technology, a controller 20, a supply 7 of a fluid 5 (FIG. 7), and a receiver 9.

The supply 7, the fluid 5 and the receiver 9 may be any suitable supply, fluid and receiver. The supply 7 may be a container containing a quantity of the fluid 5 and from which the fluid 5 is to be drawn, for example. The receiver 9 may be a container or further processing station to which the fluid 5 is to be delivered or dispensed.

The fluid 5 may be a liquid and/or a gas. In some embodiments, the fluid 5 is a material that is caustic or corrosive to plastic. In some embodiments, the fluid 5 is a material that is caustic or corrosive to metal. In some embodiments, the fluid 5 is an acid.

The pump assembly 50 includes a chassis 100, a drive 110 and a pump mechanism 120. It will be appreciated that the pump mechanism 50 can be used in combination with supports and drive systems of other designs and constructions.

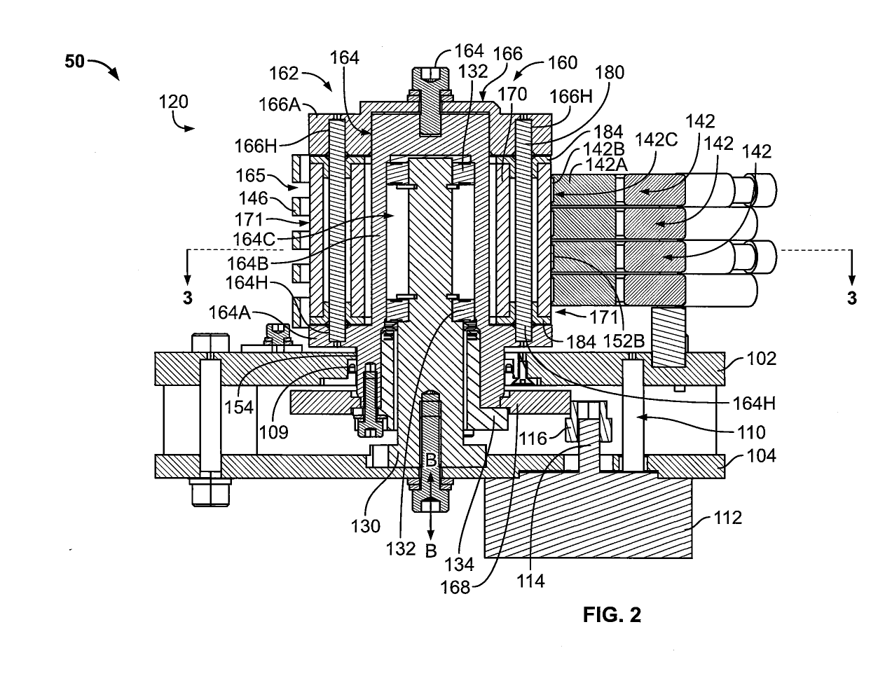

The chassis 100 includes a base 102 coupled to a subframe 104 by damping mounts 106. A through bore 154 is defined in the base 102. An annular contact or wiper seal 109 is positioned adjacent the through bore 154 (FIG. 2).

With reference to FIG. 2, the drive system 110 includes a motor 112 having a rotatable output shaft 114. The motor 112 may be any suitable motor and, in some embodiments, is an electric motor configured to be selectively actuated and deactuated by the controller 20. A drive gear 116 is affixed to the output shaft 114 for rotation therewith.

The pump mechanism 120 includes a primary axle 130, a pump housing or casing 140, one or more elastically deformable or flexible tubes 150, and a rotor assembly 160.

The primary axle 130 is affixed at its base to the subframe 104 and has bearings 132 mounted on its upper and mid sections. The bearings 132 may be roller bearings, for example.

The pump housing 140 includes a plurality of rigid, semi-circular clamps 142 and a fixed housing section or shroud 146 collectively defining a pump chamber 141. Each clamp 142 includes a clamp body 142A, an arcuate, inner contact wall 142B, a groove 142C (defined in part by the contact wall 142B), and a pivot end 142D. Each clamp is pivotally coupled to the base 102 by a pivot bolt 142F at its pivot end 142D and releasably secured in a closed position adjacent the rotator assembly 160 by a locking mechanism 143 at its opposing end 142E. Slots 146A, 146B are defined in the shroud 146 and generally align with the grooves 142C. The shroud 146 is affixed to the base 102 by bolts, for example.

The clamps 142 may be formed of any suitable material or materials. According to some embodiments, the clamps 142 are formed of carbon filled polyphenylene sulfide (PPS; e.g., RYTON™).

The shroud 146 may be formed of any suitable material. According to some embodiments, the shroud 146 is formed of a metal (e.g., anodized aluminum, steel or stainless steel, which may be painted or coated).

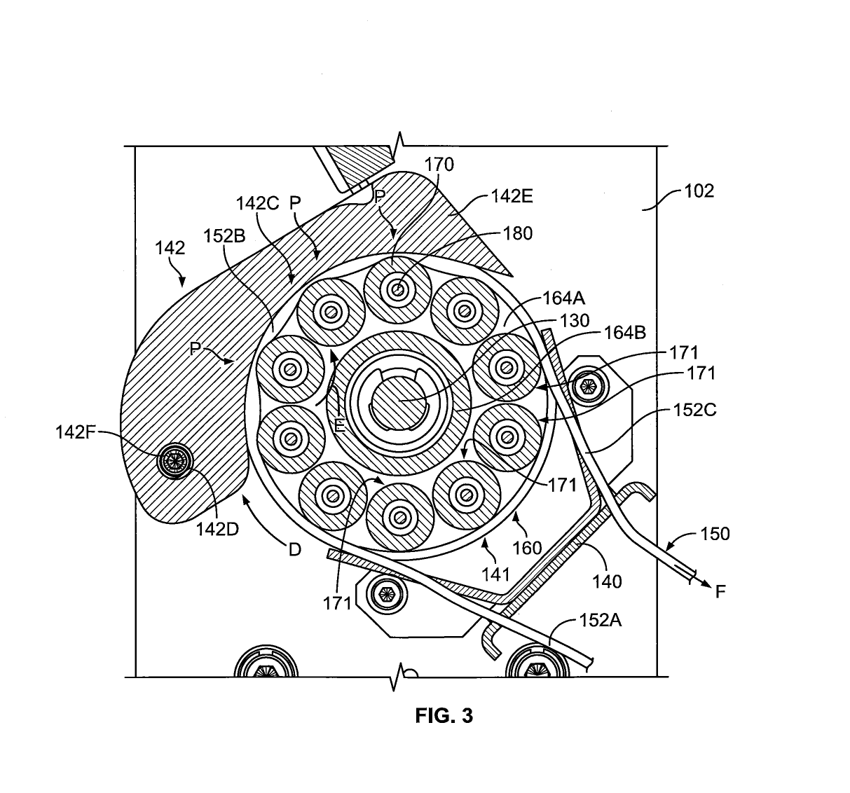

Each flexible tube 150 (FIGS. 3 and 7) includes an inlet section 152A, an intermediate section 152B, and an outlet section 152C. Each tube 150 defines a through passage 154 extending continuously from an inlet to an outlet. Each tube 150 has an inner surface 158A (defining the through bore 154) and an outer surface 158B. The tubes 150 may be formed of any suitable flexible, resilient material or materials. Suitable materials may include Tygon tubing, for example.

The rotor assembly 160 (FIGS. 2-5) includes a roller carrier 162 and a plurality of roller assemblies 171. Each roller assembly 171 includes a roller axle pin 180, a pair of annular or tubular roller bushings 184 mounted on the roller axle pin 180, and a tubular roller 170 mounted on the bushings 184.

The roller carrier 162 includes a hub 164 and an end cap 166 coupled by a bolt 167. The hub 164 includes a shaft section 164B and a lower flange 164A extending radially outwardly from the shaft section 164B. A central bore 164C is defined in the section 164B. The end cap 166 includes an upper flange 166A extending radially outwardly. The flanges 164A and 166A define an annular roller receiving channel 165 therebetween. A driven gear 168 is affixed to the lower end of the hub 164 and operably engages the drive gear 116 to be driven thereby. Roller mounting bores 164H, 166H are defined in each flange 164A, 166A for each roller 170.

The roller carrier 160 may be formed of any suitable material. According to some embodiments, the roller carrier 160 is formed of polyoxymethalene plastic (e.g., Delrin™), PPS, or stainless steel coated with diamond-like carbon.

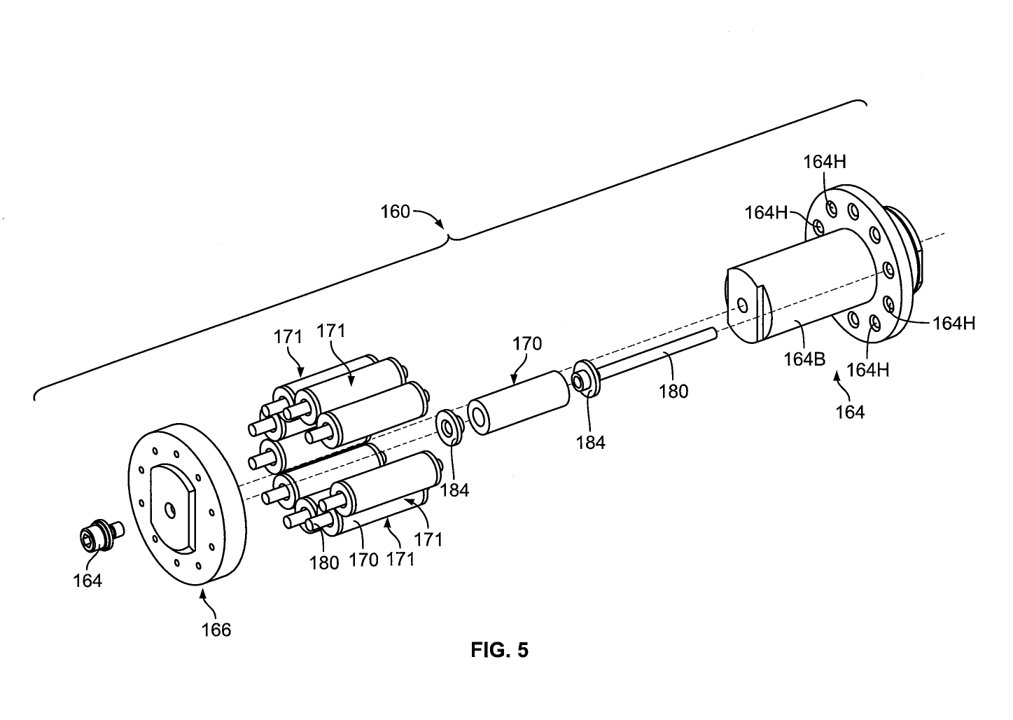

With reference to FIGS. 5-7, each roller 170 includes a tubular body 172 having an outer contact surface 174 and a through bore 176 extending axially through the body 172. According to some embodiments, each contact surface is cylindrical. Each of the bushings 184 of the corresponding roller assembly 171 includes a tubular body portion 184A and a radially outwardly extending end flange 184B. Each bushing 184 is mounted with its body portion 184A seated in the through bore 176 and its flange 184B covering an end face of the roller 170. The axle pin 180 of the corresponding roller assembly 171 extends through each bushing 184 and has end sections 182 extending axially outwardly beyond the opposed ends of the roller 170. The outer diameter of each bushing body portion 184A forms an interference fit with the inner diameter of the roller 170, and the inner diameter of the bushing body portion 184A forms a loose or sliding fit with the outer diameter of the axle pin 180. Each roller 170 is thereby freely or loosely rotatable about and with respect to its axle pin 180.

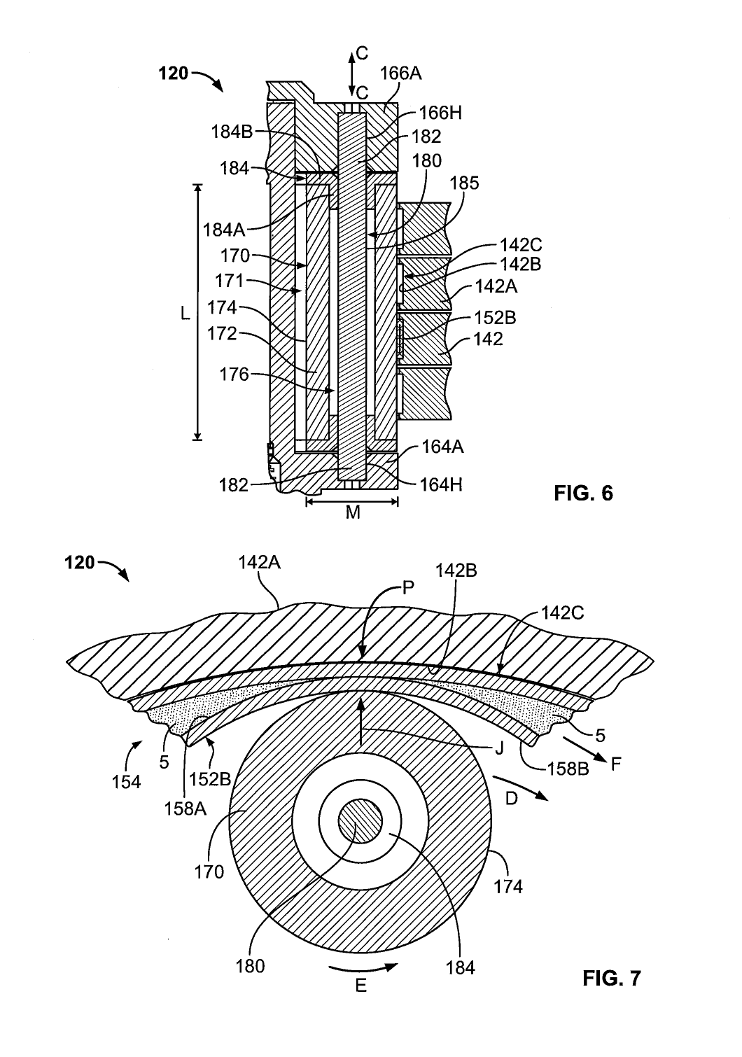

The opposed ends 182 of each axle pin 180 are seated in opposed roller mounting bores 164H, 166H of the flanges 164A, 166A (FIG. 6). According to some embodiments, the inner diameter of each of the bores 166H is slightly less than the outer diameter of the end section 182 received thereby so that the end section 182 is secured in the bore 166H by an interference or press fit. According to some embodiments, the inner diameter of each of the bores 164H is slightly greater than the outer diameter of the end section 182 received thereby so that the end section 182 is slip fit in the bore 164H.

According to some embodiments, the rollers 170 are evenly spaced apart circumferentially about the hub 164.

The outer contact surfaces 174 and 185 of the rollers 170 and the axle pins 180 each formed of borosilicate glass. According to some embodiments, the rollers 170 and the axle pins 180 are each formed entirely or substantially entirely of borosilicate glass. In some embodiments, the rollers 170 and the axle pins 180 are each monolithic. Suitable borosilicate glass for the rollers 170 and the axle pins 180 may include Pyrex™ borosilicate glass available from Arc International.

The rollers 170 and the axle pins 180 may be formed in any suitable manner. In some embodiments, the rollers 170 and the axle pins 180 are each extruded as rods, cut to length, machined and polished.

According to some embodiments, the surface finish of the contact surface 174 of each roller 170 in the range of from about 3 to 5 microinch RMS (root mean square). In some embodiments, the contact surfaces 174 are flame polished.

According to some embodiments, the borosilicate glass forming the contact surfaces 174 has a Knoop hardness in the range of from about 400 to 450 kg/mm².

According to some embodiments, the outer diameter M (FIG. 6) of each roller 170 is in the range of about 10 to 20 mm. According to some embodiments, the length L (FIG. 6) of each roller 170 is about 30 to 60 mm.

According to some embodiments, the bushings 184 are formed of polytetrafluoroethylene (PTFE; e.g., Teflon™) or PPS.

The rotor assembly 170 is mounted over the primary axle 130 on the bearings 132 for rotation about a central rotation axis B-B. The rotor assembly 160 may be secured in place by a locking collar 134. The tubes 150 are looped about the rotor assembly 160 and the central rotation axis B-B as shown in FIGS. 1-3. More particularly, the intermediate section 152B of each tube 150 extends around the outer diameter of the rotor assembly 160 between the rotor assembly 160 and a respective clamp 142 such that the tube 150 is seated in the groove 142C of the clamp 142. The tube sections 152C and the rotor assembly 160 are thus both disposed in the pump chamber 141. The inlet section 152A of the tube 150 is fluidly connected to the supply 7 and the outlet section 152B is fluidly connected to the receiver 9.

In operation, one or more of the tubes 150 may be used to pump the fluid 5. For the purpose of explanation, only a single tube 150 will be described below. It will be appreciated, however, that this discussion likewise applies to operation using the other tubes 150 individually or simultaneously.

With the tube 150 looped about the rotor assembly 160, the clamp 142 is closed and locked to the shroud 146 using the locking mechanism 143 to capture and compress the tube 150 between the clamp 142 and the rotor assembly 160. The controller 20 operates the motor 112 to drive the rotor assembly 160 to rotate in a circular direction D about the central axis B-B. The spacing blank between the rollers 170 and the clamp 142 when they are circumferentially adjacent is less than the outer diameter of the relaxed tube 150. As the rotor assembly 160 rotates, the rollers 170 orbit the central axis B-B. The rollers 170 in contact with the tube 150 rotate (in a direction E (FIG. 3) about the roller axis C-C (FIG. 6)) over the intermediate section 152B and thereby sequentially locally radially compress or pinch the intermediate section 152B in a pinched direction J (FIG. 7) against the clamp wall 142B. The rollers 170 thereby operate as pressing elements while the clamp wall 142B serves as an occlusion bed. In some embodiments, the rollers 170 fully occlude the through passage 154 at the pinched locations P (FIGS. 3 and 7). In some embodiments, the rollers 170 do not fully occlude the through passage 154.

As the rotor assembly 160 is rotated, the pinched point or location P of each contacting roller 170 moves or translates progressively down the length of the tube 150 toward the outlet section 152C. In this manner, the fluid 5 in the through bore 154 is squeezed or pushed ahead of the rollers 170 in a fluid flow or displacement direction F (FIG. 7) through the through passage 154 along the longitudinal axis of the tube 150. The pump mechanism 120 thereby operates as a positive displacement pump. After the roller 170 passes over the section of the tube 150, the tube 150 will resiliently or elastically return (restitution) to its original relaxed or radially expanded state, thereby inducing or drawing more fluid 5 from the supply 7 into through bore 154. This additional fluid 5 is pushed through the through bore 154 by the next revolution of the rotor assembly 160. The fluid 5 exits the pump mechanism 120 through the tube outlet section 152C.

The repeated compression and restitution of the tube 150 may eventually cause the tube 150 to break, rupture, or fail and permit the fluid 5 to leak out from the tube 150 into the surrounding regions of the pump mechanism (e.g., into the pump chamber 141). For example, pin holes, slits or splits may form in the tube 150 through which the fluid 5 may leak. Moreover, the tube 150 may come loose from couplings in the pump, permitting fluid to leak into the pump. In peristaltic pumps of the prior art, the leaked fluid may damage or contaminate the pump mechanism and thereby reduce its performance and/or service life. In particular, the metal rollers of known peristaltic pumps may be corroded by the leaked fluid 5.

The foregoing problems may be solved or reduced by the rollers 170 of the pump mechanism 120 having contact surfaces 174 formed of borosilicate glass. The borosilicate glass is inert to most materials and therefore is resistant to corrosion by these materials. In particular, the borosilicate glass is substantially inert to almost all acids. According to some embodiments, the fluid 5 is an acid and, according to some embodiments, the fluid 5 is an acid to which borosilicate glass is inert (e.g., Aqua Regia, nitric acid (e.g., up to 30% HNO₃), hydrochloric acid (e.g., up to 30% HCl), sulfuric acid (e.g., up to 20% H₂SO₄, phosphoric acid (e.g., up to 10% H₃PO₄), methyl isobutyl ketone (MIBK), and/or Xylene. Thus, in the event of leakage of the fluid 5 onto the rollers 170, it may not be necessary to replace the rollers 170 or suffer loss of performance resulting from damage to the rollers 170. Because the roller axle pins 180 are likewise formed of borosilicate glass, they can likewise be resistant to corrosion.

The borosilicate glass of the rollers 170 and axle pins 180 is also very hard and the contact surfaces 174 can be formed (e.g., by grinding and polishing) very smooth with high dimensional tolerances and consistency. The hard and very smooth contact surface 174 may provide longer tube life so that the tubing requires replacement less frequently. The high dimensional tolerances of the contact surface 174 may allow the rollers 170 to run more smoothly, with very little slop. This may result in a more consistent flow through the pump mechanism 120, with less pulsation. Because the borosilicate glass is corrosion resistant, these performance improvements may be maintained even after the rollers 170 are exposed to leaked fluid 5.

According to some embodiments, the pump mechanism 120 is used to pump fluid to a spectrometer or other precision fluid analysis apparatus. The foregoing benefits of the borosilicate glass rollers 170 may be particularly beneficial when used to feed the fluid to such apparatus. The more consistent and stable pumping performance afforded by the hard, smooth, corrosion resistant rollers 170 can enable better sensitivity in the data collected and more reliable and accurate analytic results.

The wiper seal 109 can serve to inhibit or prevent leaked fluid 5 from flowing down below the rotor assembly 160 where it may damage other components.

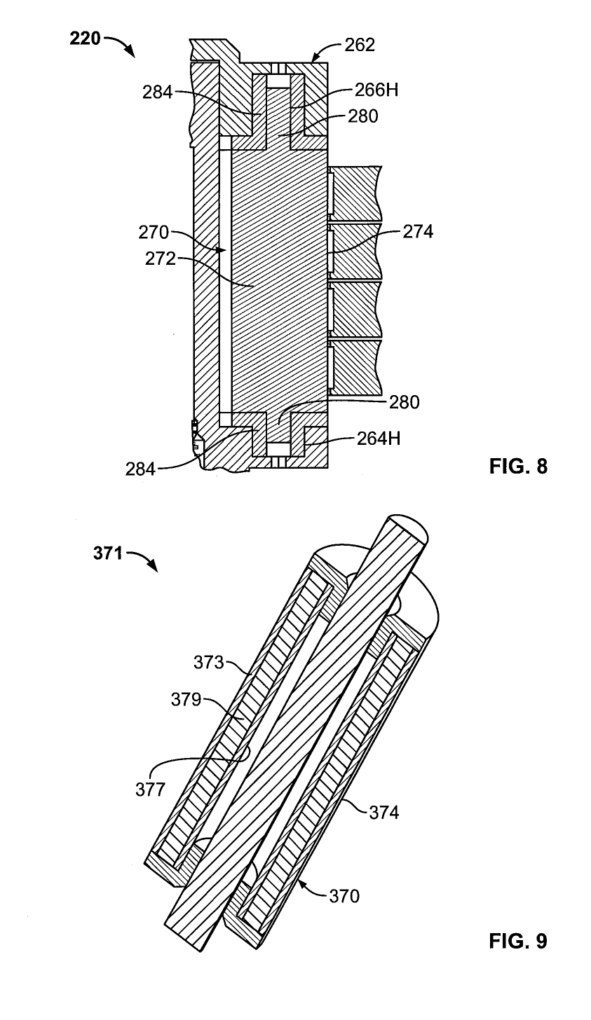

With reference to FIG. 8, a pump mechanism 220 according to further embodiments of the technology is shown therein. The pump mechanism 220 may be used in place of the pump mechanism 120 and is constructed in the manner as the pump mechanism 120 except as follows. The pump mechanism 220 employs rollers 270 each having a roller body 272 and integral axle pins 280 extending from opposed ends of the roller body 272. At least the contact surface 274 of each roller 270 is formed of borosilicate glass and, in some embodiments, the entirety of each roller 270 is formed of borosilicate glass. According to some embodiments, each roller 270 is monolithic. The axle pins 280 are rotatably received in the pin bores 264H, 266H of the roller carrier 262. In some embodiments, bushings or other bearings 284 are provided in the bores 264H, 266H between the roller carrier 262 and the axle pins 280.

With reference to FIG. 9, a roller assembly 371 including a roller 370 according to further embodiments of the technology is shown therein. The roller 370 may be used in place of the rollers 170. The roller 370 differs from the rollers 170 in that the roller 370 is not formed entirely of borosilicate glass. Instead, the roller 370 has a core 379 of a material other than borosilicate glass and a cladding layer 373 of borosilicate glass. In some embodiments, the core 379 is formed of a metal such as stainless steel. The cladding layer 373 forms the tube contact surface 374 and may also form the axle pin contact surface 377 and/or roller end surfaces.

According to further embodiments, the mounting bores 164H and/or 166H may have an inner diameter significantly greater than the outer diameter of the opposed ends 182 of the axle pins 180 and the end sections 182 may be secured in the bores mounting bores 164H and/or 166H by resilient securing members. According to some embodiments, the securing members are elastomeric (e.g., rubber) O-rings. The resilient securing members can secure the end sections 182 without risking breakage of the borosilicate glass.

In some embodiments, washers are mounted on the end sections 182 between the ends of the rollers 170 and the flanges 164A, 166A. According to some embodiments, the washers are formed of polytetrafluoroethylene (PTFE; e.g., Teflon™) or PPS.

In the same embodiments, the thickness of the cladding layer 373 is in the range of from about 0.4 to 0.6 mm.

Many alterations and modifications may be made by those having ordinary skill in the art, given the benefit of present disclosure, without departing from the spirit and scope of the technology. Therefore, it must be understood that the illustrated embodiments have been set forth only for the purposes of example, and that it should not be taken as limiting the technology as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the technology.

What is claimed is:

1. A peristaltic pump for pumping a fluid, the peristaltic pump comprising:
a flexible tube having inner and outer tubular opposed walls, the inner wall defining a through passage to receive the fluid; and
at least one roller having an outer contact surface;
wherein the peristaltic pump is configured to compress the flexible tube with the contact surface of the roller to thereby force the fluid through the through passage; and
wherein at least the contact surface of the roller is formed of borosilicate glass, the peristaltic pump further comprising:
a roller carrier; and
a roller axle pin coupling the roller to the roller carrier;
wherein the roller axle pin is formed of borosilicate glass and the roller axle pin is stationary with respect to the roller carrier and the roller is rotatable about the roller axle pin.

2. The peristaltic pump of claim 1 wherein the contact surface engages an outer surface of the tube to compress the flexible tube.

3. The peristaltic pump of claim 1 wherein the roller is formed entirely of borosilicate glass.

4. The peristaltic pump of claim 1 including a roller bushing mounted between the roller axle pin and the roller to permit relative rotation therebetween.

5. The peristaltic pump of claim 1 wherein the roller includes:
a core of a material other than borosilicate glass; and
a cladding layer of borosilicate glass surrounding the core and forming the contact surface.

6. The peristaltic pump of claim 1 wherein the at least one roller comprises a plurality of rollers each having an outer contact surface formed of borosilicate glass, wherein the peristaltic pump is configured to compress the flexible tube with the contact surfaces of each of the rollers to thereby force the fluid through the through passage.

7. The peristaltic pump of claim 6 including a roller carrier, wherein:
the plurality of rollers are each rotatably mounted on the roller carrier; and
the roller carrier is rotatable about a central axis such that the plurality of rollers orbit the central axis and sequentially compress the tube when the roller carrier is rotated about the central axis.

8. A method for pumping a fluid, the method comprising:
providing a peristaltic pump including:
a flexible tube having inner and outer tubular opposed walls, the inner wall defining a through passage to receive the fluid; and
at least one roller roller having an outer contact surface;
wherein the peristaltic pump is configured to compress the flexible tube with the contact surface of the roller to thereby force the fluid through the through passage; and
wherein at least the contact surface of the at least one roller is formed of borosilicate glass, the peristaltic pump further comprising:
a roller carrier; and
a roller axle pin coupling the roller to the roller carrier;
wherein the roller axle pin is formed of borosilicate glass and the roller axle pin is stationary with respect to the roller carrier and the roller is rotatable about the roller axle pin; and
pumping the fluid through the flexible tube using the peristaltic pumping including compressing the flexible tube with the contact surface of the roller to thereby force the fluid through the through passage.

9. The method of claim 8 wherein the fluid is corrosive or caustic to stainless steel.

10. The method of claim 8 wherein the fluid is an acid.

11. The method of claim 8 wherein pumping the fluid through the flexible tube using the peristaltic pump includes engaging the contact surface with an outer surface of the tube to compress the flexible tube.

12. The method of claim 8 wherein the roller is formed entirely of borosilicate glass.

13. The method of claim 8 wherein the peristaltic pump includes a roller bushing mounted between the roller axle pin and the roller to permit relative rotation therebetween.

14. The method of claim 8 wherein the roller includes:
a core of a material other than borosilicate glass; and
a cladding layer of borosilicate glass surrounding the core and forming the contact surface.

15. The method of claim 8 wherein:
the at least one roller of the peristaltic pump includes a plurality of rollers each having an outer contact surface formed of borosilicate glass; and
pumping the fluid through the flexible tube using the peristaltic pump includes compressing the flexible tube with the contact surfaces of each of the rollers to thereby force the fluid through the through passage.

16. The method of claim 15 wherein:
the peristaltic pump includes a roller carrier;
the plurality of rollers are each rotatably mounted on the roller carrier; and
pumping the fluid through the flexible tube using the peristaltic pump includes rotating the roller carrier about a central axis such that the plurality of rollers orbit the central axis and sequentially compress the tube when the roller carrier is rotated about the central axis.
